(19) United States
(12) Patent Application Publication
(10) Pub. No.: US 2007/0089785 A1
(43) Pub. Date: Apr. 26, 2007

(54) Method of shear heating of heavy oil transmission pipelines

(75) Inventor: Glen F. Perry, Pender Island (CA)

Correspondence Address: MACPHERSON KWOK CHEN & HEID LLP, 2033 GATEWAY PLACE, SUITE 400, SAN JOSE, CA, 95110, US

(73) Assignee: ALTEX ENERGY LTD., Calgary (CA)

(21) Appl. No.: 11/260,067

(22) Filed: Oct. 26, 2005

(51) Int. Cl. G05D 23/185

(52) U.S. Cl. 137/13

(57) ABSTRACT

A method and apparatus for transporting heavy oil in a pipeline using shear heating. Shear heating provided by external friction or internal friction acts to heat the heavy oil to increase or maintain the temperature of the heavy oil as it flows through the pipeline. The pipeline may be designed to enhance shear heating.

### FIELD OF THE INVENTION

The Invention relates to the field of oil and gas. In particular, the Invention, in one embodiment, is a method of using shear heating effect for the long distance pipeline transportation of heavy oil.

### BACKGROUND OF THE INVENTION

The state of the prior art can be summarized by the following quotation, taken from a paper presented in the Oct. 26, 1998, issue of the Oil and Gas Journal. The paper is called “Drive to produce heavy crude prompts variety of transportation methods”, by A. Gustavo, H. J. Rivas Nunez and D. D. Joseph. The statement is as follows:
“It is important to note that the external heating of the oil can be partially frustrated by heat losses from the pipe walls when the flow velocity is low . . . Heat losses will always occur and the heating method can work only (emphasis added) when the oil is reheated in the pumping stations. Direct fired heaters are generally used to raise the oil temperature; they can be natural gas or fuel fired.”

### SUMMARY OF THE INVENTION

It is an object of the Invention to overcome limitations in the prior art.

It has been found that it is possible to design a long distance, non-insulated, heavy oil transmission pipeline that can be heated using a principle referred to here as shear heating. This principle refers to the fact that, using appropriate design factors, the temperature in the pipeline will naturally (without the injection of heat) increase above ground temperature, and will remain at this elevated state, even when the line is not insulated. The increased temperature shows a benefit in reducing the viscosity of the heavy oil, and thus allowing for greater throughput at a lower power requirement. The temperature can be controlled by varying the design choices of line diameter, station spacing, operating pressure range and the viscosity specification of the transported oil at ambient temperature.

In one aspect, the present invention provides a method of transportation of heavy oil in a substantially underground pipeline by increasing or maintaining the temperature of the heavy oil within the pipeline using shear heating.

Preferably, the shear heating is provided by external friction within a pump. Preferably, the shear heating is provided by internal shear friction within the flow of the heavy oil. Preferably, the pipeline is substantially non-insulated or poorly insulated. Preferably, the heavy oil has an API gravity of less than 26 degrees API.

Preferably, shear heating acts to raise the temperature of the heavy oil at a rate designed to substantially match, within desired parameters, the effect of pipeline conditions in lowering the temperature of the oil, to produce an equilibrium oil temperature. Preferably, the equilibrium oil temperature, defined as substantially the asymptote of the temperature versus time graph, averaged over substantially the length of the pipeline is at least about 15° F. (8.3° C.) above the average ground temperature at the pipeline's operating condition. Preferably, the method further comprises the step of heating the heavy oil to substantially the equilibrium oil temperature before using shear heating for increasing or maintaining the temperature of the heavy oil.

Preferably, a portion of the pipeline comprises a feature for increasing shear heating. Preferably, the feature comprises a section of reduced pipeline diameter, a flow restriction, a mixer, internal blades or vanes, an uncoated pipeline wall, a roughened pipeline wall, or a combination thereof.

Preferably, the heavy oil is cooled to keep the heavy oil substantially at or below a selected temperature. Preferably, the selected temperature corresponds substantially to the design pressure and temperature limits of the pipeline. Preferably, the design temperature limit of the pipeline is selected on the basis of an external coating temperature limit or an environmental design temperature limit.

Preferably, the shear heating in at least a segment of the pipeline is controlled by controlling the pressure drop of the heavy oil within the pipeline, wherein a larger pressure drop yields more shear heating of the heavy oil. Preferably, the shear heating is tailored for at least a segment of the pipeline by tailoring flow velocity and pressure drop within the segment (assuming no change to other inputs such as constitution of heavy oil, starting temperature and pressure, pipeline diameter and environmental conditions), the flow velocity and/or discharge pressure being tailored by adjustment of pump horsepower and pump operating pressure range.

Preferably, the pipeline has a length of at least about 160 miles (266 km) (i.e. the pipeline is a “long-haul” pipeline). More preferably, the pipeline has a length of at least about 300 miles (500 km).

Preferably, selected portions of the pipeline are thermally insulated to reduce heat loss in the selected portions. Preferably, the selected portions comprise river crossings, surface projections (expansion loops, surface valves or piping, meter stations, etc.), or regions where the ground has a higher thermal conductivity (e.g. wet soil).

Preferably, the heavy oil comprises a blend or mixture of heavier oil and a diluent. Preferably, the diluent is a hydrocarbon having five or fewer carbon atoms. Alternatively, the diluent is a hydrocarbon having six or more carbon atoms. Preferably, the diluent is selected from a group of high (>atmospheric) vapor pressure products comprising, ethane, propane, n-butane, i-butane, ethylene, propylene and butylene. Preferably, the heavy oil has an API gravity of less than about 26 degrees API.

In a further aspect, the present invention provides a method of selecting the route of a substantially non-insulated substantially underground pipeline in order to facilitate a shear heating effect, comprising the steps of assessing a plurality of possible routings, considering at least one detracting factor, the at least one detracting factor known to effect or at least partially overcome the shear heating effect in achieving or maintaining the pipeline's equilibrium temperature; and selecting one of the plurality of possible routings based on the minimization or reduction in the at least one detracting factor.

Preferably, the at least one detracting factor is selected from the group of ground thermal conductivity, river crossing required, or surface projections (expansion loops, surface valves or piping, meter stations, etc.). Preferably, underground moisture affects the ground thermal conductivity.

In a further aspect, the present invention provides a pipeline for transporting heavy oil, the pipeline adapted to benefit from shear heating, the pipeline having a maximum operating pressure (MOP) greater than about 800 psia, an operational average pressure drop greater than about 10 psi/mile, and a equilibrium oil temperature, defined as substantially the asymptote of the temperature versus time graph, averaged over substantially the length of the pipeline, of at least about 15° F. (8.3° C.) above the average ground temperature, at the pipeline's operating condition.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiment of the present invention will now be described, by way of example only, with reference to the attached FIGURE, wherein:

FIG. 1 displays the results from a hydraulic simulation of an embodiment of the Invention.

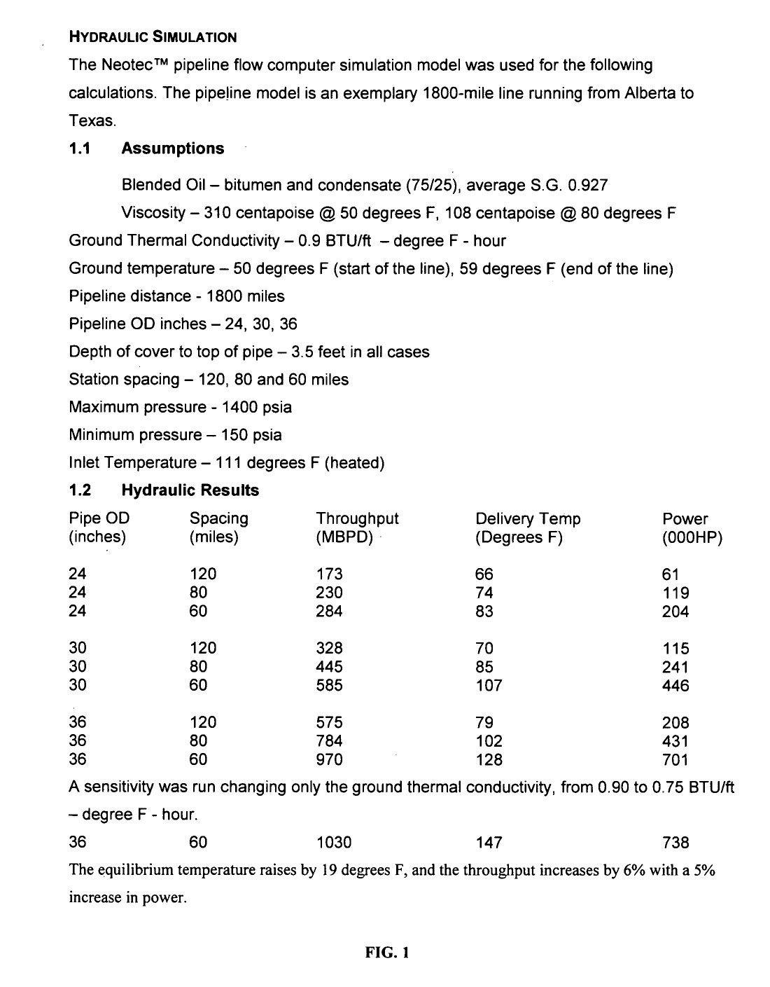

### DETAILED DESCRIPTION

The following described embodiments of the Invention display preferred methods but are not intended to limit the scope of the Invention. It will be obvious to those skilled in the art that variations and modifications may be made without departing from the scope and essential elements of the Invention.

For heavy oil and bitumen oil involved in long distance pipeline transportation, the designed viscosity specification of oil pipelines is usually met by blending the heavy oil with a lighter hydrocarbon compound. Natural gasoline, pentane plus or naphtha is traditionally used because of their low vapor pressure. Traditional oil pipelines operate with a low vapor pressure restriction, close to ambient pressure, in order to maximize their capacity. This restricts the choice of blending compounds to C5+ or heavier. For example, an older pipeline with a maximum operating pressure (“MOP”) of 800 psia, operating down to 25 psia, has 775 psia of useful pressure drop between pump stations to define the throughput. Raising the minimum pressure to 150 psia would reduce throughput significantly. Increasing the maximum pressure to 925 psia would re-establish the lost capacity, however this is not possible with an existing line already operating at MOP. When designing a new line, the minimum and maximum operating pressure can be designed so that the shear heating effect, which permits this Invention's benefits, can be predicted and controlled and the range of available blending compounds used to vary the base heavy oil or bitumen oil viscosity for transport is broadened. The new line could, for example, range between 1400 psia and 150 psia, allowing for both a greater oil velocity between stations and a higher vapor pressure limit.

With a minimum vapor pressure limit of 150 psia, a new pipeline can use hydrocarbon compounds lighter than natural gasoline for blending, such as ethane, propane or butane. This has an advantage in areas such as Alberta, Canada, where the available supply of C5+ is limited, and thus carries an economic penalty as a diluent, while the available supplies of C2, C3 and C4 are plentiful, and can be purchased for a discount relative to the value of the commodities at the destination of the pipeline.

The resulting system has a pressure drop of 1250 psia between stations, sufficient to generate the shear heating effect.

The shear heating effect is initiated by two factors. The first is the small temperature increase that occurs in the pump through friction, as the oil is increased in pressure. This is dependent on the pressure rise and tends to increase the oil temperature by about 1-2 degrees Fahrenheit. The second is the heat generated by internal shear friction within the oil as it flows through the pipeline. This shear friction translates into heat. When the sum of these two heat inputs exceeds the ability of the non-insulated pipe to radiate heat to the surrounding ground, the temperature of the oil will continuously increase until an equilibrium temperature is reached, where the heat generation is equal to the heat loss. As the temperature of the oil rises, the viscosity and internal shear friction reduces and therefore the shear friction heat generation reduces. Also, as the temperature rises, the heat loss to the environment increases with the difference in temperature between the oil and the environment.

For some of the designs, the net temperature increase can add upwards of 1 degree Fahrenheit for every 10-20 miles of distance, with an equilibrium temperature of 150 degrees Fahrenheit.

Rather than wait for this effect to slowly heat the oil as it travels down the pipeline, and be limited in pipeline capacity by the operating conditions over the initial distance traversed, one design using or embodying the invention would include a heater at the front end of the pipeline, so that this target equilibrium temperature was induced in the oil being injected into the pipeline at the outset. In this fashion, the equilibrium temperature (and other operating factors) would be maintained throughout the pipeline system.

In the event that the equilibrium temperature exceeds a maximum design temperature limit, dictated by other factors such as environmental impact, external coating, or steel expansion, the oil can be cooled by the use of low cost aerial radiators or similar coolers at selectively spaced stations. This is possible because the heating effect is quite gradual, usually taking several pump stations to rise by 10 degrees Fahrenheit.

The key contributing factors to the shear heating effect are summarized below:
1. The higher the oil viscosity, the greater the internal shear friction and the more heat is generated. This shear heating effect is not seen with normal light and medium gravity oil as the viscosity within the transport system is too low. The upper limit on viscosity on long distance pipelines specifically designed for heavy oil will usually be dictated by the pipeline's shut-down condition. The oil must be able to move after an extended shut-down, when it has cooled to the ambient temperature. This would, for example, prevent pure bitumen with a viscosity of 250,000 cp at 50 degrees Fahrenheit from being used, and would dictate the need for some blending. In the following examples, a 75%/25% bitumen-to-condensate blend is assumed. This blend has an assumed viscosity of 310 cp at 50 degrees Fahrenheit and 108 cp at 80 degrees Fahrenheit. If the shut-down condition is not a key design feature, because the cool down time is so long that pipeline start-up can be guaranteed within the time window, then even higher viscosity oils can be assumed and the shear heating effect is increased.
2. The higher the velocity and pressure drop per unit distance, the greater the heat generation. For practical applications, this means that the pipeline must be in turbulent flow or partially turbulent flow. The high velocity is achieved by utilizing a large pressure drop between pump stations, and in using relatively tight station spacing. The following example assumes a pump station outlet of 1400 psia, a pump station inlet of 150 psia, and station spacing between 60 and 120 miles. The resulting velocity is 4-10 feet per second.
3. The greater the pipe diameter, the greater the ratio between oil volume (radius squared) and heat radiating surface area (radius). The following example assumes three pipe sizes of 24″, 30″ and 36″ diameter. The effect is seen to be greater with the larger diameters.
4. The equilibrium temperature is very sensitive to the ground thermal conductivity. Typical North American soil conditions range from 0.6 to 0.9 BTU/ft-degree F.-hour in the summer and 0.8 to 1.1 in the winter. The following example is based on 0.9 for summer conditions, which would represent a wet, clay-like soil, with about the highest heat conductivity of all soils expected to be encountered. The equilibrium temperature would be higher with more typical dry or naturally insulating soils.

The impact of higher oil temperature on pipeline capacity is to reduce the viscosity of the oil. With all else being equal (minimum and maximum pressure, line size, station spacing, elevation), at similar throughput, this viscosity reduction reduces the pressure drop between stations. Alternatively, at a similar pressure drop between stations, this viscosity reduction allows for an increase in throughput. The increase in throughput for the 60-mile station spacing between using the referenced oil blend at 50 degrees Fahrenheit and 310 cp and in using the referenced oil blend at 130 degrees Fahrenheit and 28 cp is approximately 40%. This requires a 40% increase in pump horsepower, however all the other aspects of the system remain the same. As the pump station horsepower represents about 25% of the total system capital and operating cost, one achieves 140% of the throughput at 110% of the cost. The unit cost of transportation reduces by about 21% ( 30/140). This is one measure of the economic value of the invention.

All aspects of the Invention may be comprised of any suitable material or methods, including but not limited to: pipeline greater than 300 miles in length; oil which has an API gravity of less than 26 degrees API; oil temperature more than 15 degrees Fahrenheit hotter than the ground temperature; temperature maintained without the use of external heating except at the initiation station; use of aerial coolers to keep the oil below the maximum operating temperature.

In the foregoing descriptions, the Invention has been described in known embodiments. However, it will be evident that various modifications and changes may be made without departing from the broader scope and spirit of the Invention. Accordingly, the present specifications and embodiments are to be regarded as illustrative rather than restrictive.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of transportation of heavy oil in a substantially underground pipeline by increasing or maintaining the temperature of the heavy oil within the pipeline using shear heating.

2. The method of claim 1, wherein the shear heating is provided by external friction within a pump.

3. The method of claim 1, wherein the shear heating is provided by internal shear friction within the flow of the heavy oil.

4. The method of claim 1, wherein the pipeline is substantially non-insulated or poorly insulated.

5. The method in claim 1, wherein the heavy oil has an API gravity of less than 26 degrees API.

6. The method of claim 1, where shear heating acts to raise the temperature of the heavy oil at a rate designed to substantially match, within desired parameters, the effect of pipeline conditions in lowering the temperature of the oil, to produce an equilibrium oil temperature.

7. The method of claim 6, wherein the equilibrium oil temperature, defined as substantially the asymptote of the temperature versus time graph, averaged over substantially the length of the pipeline is at least about 15° F. (8.3° C.) above the average ground temperature at the pipeline's operating condition.

8. The method of claim 7, further comprising the step of heating the heavy oil to substantially the equilibrium oil temperature before using shear heating for increasing or maintaining the temperature of the heavy oil.

9. The method of claim 1, wherein a portion of the pipeline comprises a feature for increasing shear heating.

10. The method of claim 9, wherein the feature comprises a section of reduced pipeline diameter, a flow restriction, a mixer, internal blades or vanes, an uncoated pipeline wall, a roughened pipeline wall, or a combination thereof.

11. The method of claim 6, wherein the heavy oil is cooled to keep the heavy oil substantially at or below a selected temperature.

12. The method of claim 11 wherein the selected temperature corresponds substantially to the design pressure and temperature limits of the pipeline.

13. The method of claim 12, wherein the design temperature limit of the pipeline is selected on the basis of an external coating temperature limit or an environmental design temperature limit.

14. The method of claim 1, where the shear heating in at least a segment of the pipeline is controlled by controlling the pressure drop of the heavy oil within the pipeline, wherein a larger pressure drop yields more shear heating of the heavy oil.

15. The method of claim 1, where the shear heating is tailored for at least a segment of the pipeline by tailoring flow velocity and pressure drop within the segment (assuming no change to other inputs such as constitution of heavy oil, starting temperature and pressure, pipeline diameter and environmental conditions), the flow velocity and/or discharge pressure being tailored by adjustment of pump horsepower and pump operating pressure range.

16. The method of claim 1, wherein the pipeline has a length of at least 160 miles (266 km) (i.e. the pipeline is a “long-haul” pipeline).

17. The method of claim 16, wherein the pipeline has a length of at least 300 miles (500 km).

18. The method of claim 1, wherein selected portions of the pipeline are thermally insulated to reduce heat loss in the selected portions.

19. The method of claim 18, wherein the selected portions comprise river crossings, surface projections (expansion loops, surface valves or piping, meter stations, etc.), or regions where the ground has a higher thermal conductivity (e.g. wet soil).

20. The method of claim 1, wherein the heavy oil comprises a blend or mixture of heavier oil and a diluent.

21. The method of claim 20, wherein the diluent is a hydrocarbon having five or fewer carbon atoms.

22. The method of claim 20, wherein the diluent is a hydrocarbon having six or more carbon atoms.

23. The method of claim 20, wherein the diluent is selected from a group of high (>atmospheric) vapor pressure products comprising, ethane, propane, n-butane, i-butane, ethylene, propylene and butylene.

24. The method of claim 20, wherein the heavy oil has an API gravity of less than about 26 degrees API.

25. A method of selecting the route of a substantially non-insulated substantially underground pipeline in order to facilitate a shear heating effect, comprising the steps of:
a. assessing a plurality of possible routings, considering at least one detracting factor, the at least one detracting factor known to effect or at least partially overcome the shear heating effect in achieving or maintaining the pipeline's equilibrium temperature; and
b. selecting one of the plurality of possible routings based on the minimization or reduction in the at least one detracting factor.

26. The method of claim 25, wherein the at least one detracting factor is selected from the group of ground thermal conductivity, river crossing required, or surface projections (expansion loops, surface valves or piping, meter stations, etc.).

27. The method of claim 26, wherein underground moisture affects the ground thermal conductivity.

28. A pipeline for transporting heavy oil, the pipeline adapted to benefit from shear heating, the pipeline having a maximum operating pressure (MOP) greater than about 800 psia, an operational average pressure drop greater than about 10 psi/mile, and a equilibrium oil temperature, defined as substantially the asymptote of the temperature versus time graph, averaged over substantially the length of the pipeline, of at least about 15° F. (8.3° C.) above the average ground temperature, at the pipeline's operating condition.
